(19) United States
(12) Patent Application Publication
(10) Pub. No.: US 2007/0246673 A1
(43) Pub. Date: Oct. 25, 2007

(54) Apparatus for securing a shaft to an armature in a solenoid actuator

(76) Inventor: Raul A. Bircann, Penfield, NY (US)

Correspondence Address: DELPHI TECHNOLOGIES, INC., M/C 480-410-202, PO BOX 5052, TROY, MI, 48007, US

(21) Appl. No.: 11/407,828

(22) Filed: Apr. 20, 2006

(51) Int. Cl. F16K 31/02

(52) U.S. Cl. 251/129.15

(57) ABSTRACT

A solenoid armature having a central bore therethrough for receiving an end of a shaft passing through the armature. The shaft is shouldered to engage the armature at the entrance side of the bore. Preferably, a formed stop is provided on the shaft to transfer load between th6 shaft and the armature. At the exit side, the shaft is surrounded by a axially-compressible resilient element, preferably a wave washer retained by a retaining washer and a retaining clip attached to the shaft. A retaining groove is provided in the shaft such that the wave washer must be compressed during assembly to install the clip on the shaft. The apparatus is especially useful in an exhaust gas recirculation valve for an internal combustion engine.

### TECHNICAL FIELD

The present invention relates to solenoid actuators for linear actuation of an attached shaft; and more particularly, to an attachment system for attaching such a shaft to the armature of a solenoid actuator.

### BACKGROUND OF THE INVENTION

It is well known to employ a linear-acting solenoid actuator for linear actuation of a shaft in a mechanical process. For example, linear solenoid actuators are widely employed for actuating poppet valve stems in poppet valves such as exhaust gas recirculation (EGR) valves in internal combustion engines. Typically, the armature of the solenoid is rigidly attached to the valve stem such that the stem may be actuated in both axial directions.

In the prior art, the valve stem is attached typically by deformation such as peening over, staking, or otherwise mechanically deforming the outer end of the valve stem after passing it through an opening in the armature. Unfortunately, such deforming methods have been found to cause high stresses in the stem and/or armature, leading to permanent distortions, weakened joints, increased stack-up of manufacturing tolerances, objectionable performance, increased hysteresis, and premature failure.

In many applications, a shaft or stem position feedback sensor is in direct mechanical contact with the shaft or stem. For an EGR valve, such contact is highly desirable for flow accuracy and integration with a vehicle engine control module (ECM) for proper operation with all other engine parameters. Mechanical deformation of the stem introduces increased variation into the manufactured length of the stem and hence affects the calibration relationship between the actual position of a valve head mounted on the stem and the apparent position indicated by the position sensor.

What is needed in the art is a simple, compliant, and non-distortive means for rigidly connecting a shaft to a solenoid armature.

It is a principal object of the present invention to enhance accuracy and overall performance of a shaft being actuated by a linear solenoid actuator.

It is a further object of the present invention to improve flow accuracy and increase the working lifetime of an EGR valve in an internal combustion engine.

### SUMMARY OF THE INVENTION

Briefly described, a solenoid armature in accordance with the invention is provided with a central bore therethrough for receiving an end of a shaft which passes through the armature. The shaft is shouldered to engage the armature at the entrance side of the bore. At the exit side, the shaft is surrounded by a axially-compressible resilient element, preferably a wave washer retained by a retaining washer and a retaining clip attached to the shaft. A retaining groove is provided in the shaft such that the wave washer must be compressed during assembly to install the clip onto the shaft.

### BRIEF DESCRIPTION OF THE DRAWINGS

These and other features and advantages of the invention will be more fully understood and appreciated from the following description of certain exemplary embodiments of the invention taken together with the accompanying drawings, in which:

FIG. 1 is a front elevational cross-sectional view of a prior art solenoid-actuated poppet valve assembly;

FIG. 2 is an exploded cross-sectional view of an improved attachment system in accordance with the invention for attaching a valve stem to a solenoid armature; and

FIG. 3 is an elevational cross-sectional view of a valve stem/armature assembly in accordance with FIG. 2.

Corresponding reference characters indicate corresponding parts throughout the several views. The exemplification set out herein illustrates a currently-preferred embodiment of the invention, and such exemplification is not to be construed as limiting the scope of the invention in any manner.

### DESCRIPTION OF THE PREFERRED EMBODIMENTS

The novelty and advantages conferred by the invention may be better appreciated by first considering a prior art pintle-type valve actuated by a linear solenoid actuator.

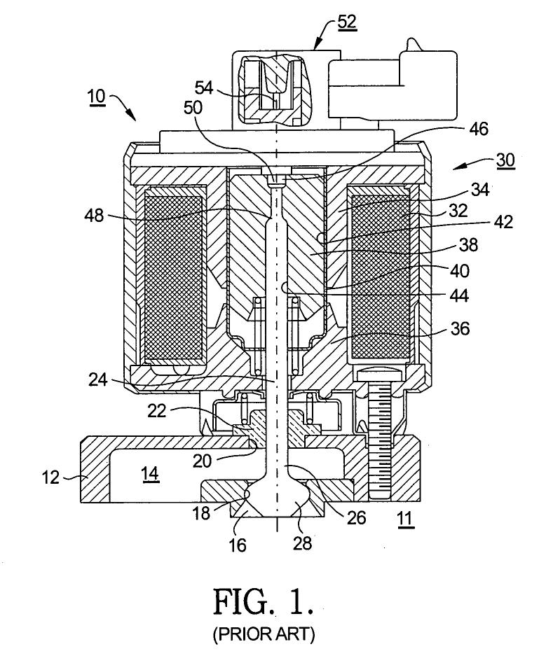

Referring to FIG. 1, a prior art poppet valve assembly 10 suitable for use as an EGR valve mountable to an internal combustion engine 11 comprises a valve body 12 defining a first chamber 14 and a second chamber 16 separated by a valve seat 18. A bore 20 in a wall of first chamber 14 is concentric with valve seat 18 and retains a bushing/seal 22 and a poppet valve stem 24 slidably disposed in bushing/seal 22. Stem 24 extends through first chamber 14 and fixedly supports, at a first end 26 within body 12, a valve head 28 for variably mating with valve seat 18 to variably open and close valve 10 between chambers 14,16 in response to axial motion of stem 24.

A linear solenoid actuator assembly 30 is mounted onto valve body 12 for actuation of valve stem 24. Actuator assembly 30 comprises windings 32 surrounding a primary pole piece 34 and a secondary pole piece 36. An armature 38 is slidably disposed within a shell 40 disposed within a first axial bore 42 in the pole pieces 34,36. A second axial bore 44 in armature 38 receives valve stem 24 which extends into a recess 46 in armature 38. Both bore 44 and stem 24 are shouldered 48 to provide a stop for limiting ingress of the stem through the bore. At a second stem end 50, after insertion through bore 44 stem 24 is flattened as by peening, staking, or other deformative process to rigidly capture stem 24 within bore 44 such that axial motion of the armature will cause identical axial motion of the valve stem. Energizing of windings 32 causes armature 38 and stem 24 to move in a downwards (as shown in FIG. 1) direction, thus bringing valve head 28 off of valve seat 18 and allowing flow between chambers 14 and 16. A valve position sensor 52 includes a probe 54 extending into mechanical contact with stem end 50 to signal the axial position thereof.

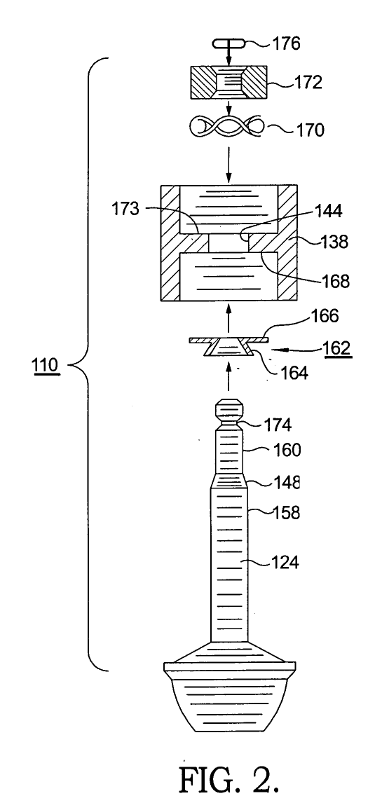

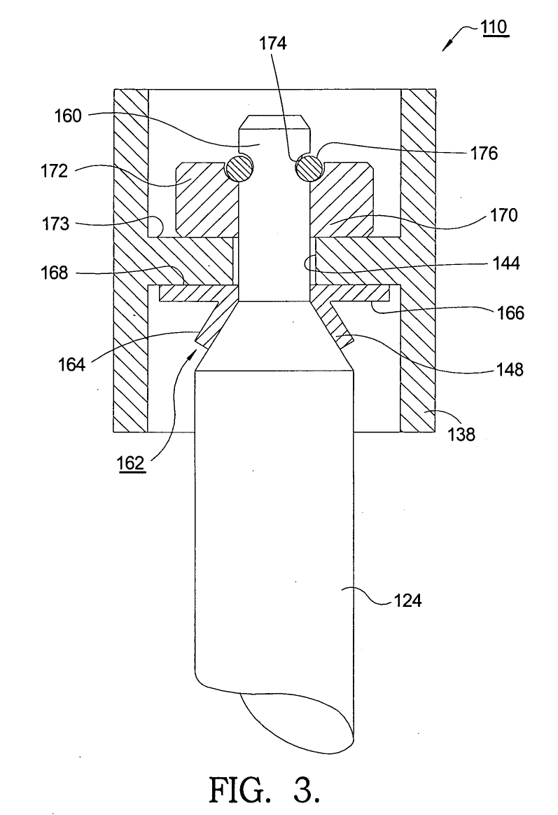

Referring to FIGS. 2 and 3, an improved attachment system 110, suitable for substitution into valve assembly 10, is shown for connecting an armature to a pintle shaft or valve stem without placing significant and permanent stress on either the stem or the armature.

An armature 138 includes an axial bore 144 for receiving stem 124. Stem 124 includes a larger diameter portion 158, a neck portion 160 and a tapered transition portion 148 therebetween. Neck portion 160 has a diameter slightly less than the diameter of bore 144 to allow for radial accommodation of the stem within the armature. A stem stop 162 surrounds stem 124 and includes a first portion 164 angled to receive tapered transition portion 148 and a second portion 166 formed to engage a first surface 168 of armature 138. Stem stop 162 serves to provide a firm engagement of tapered transition portion 148 against the broader axial surface 168 of armature 138.

After stem stop 162 and armature 138 are assembled onto stem 124, a portion of neck portion 160 protrudes through armature 138 beyond bore 144. A resilient element 170, preferably in the embodiment of an axially-compressible wave washer, is disposed around the protrudant neck portion 160 of stem 124. A washer retainer 172 is disposed onto wave washer 170 and urged into compression of wave washer 170, thereby exposing an annular groove 174 in stem 124. A retaining clip 176, for example, a split wire ring, is expanded over neck portion 160 of stem 124 and snapped into groove 174, thereby retaining the wave washer under a degree of compression between wave washer retainer 172 and second axial surface 173.

It will be recognized that the armature is now firmly attached to the stem for motion of the armature in either axial direction. The joint is extremely strong, requiring a break-loose force equal to the shear strength of the weakest of the three elements involved: stem 124, wave washer retainer 172, and retaining clip 176, all of which are preferably formed of steel.

The present method and apparatus for joining a shaft to an armature is an effective innovation for retaining the moving mass in solenoid-actuated EGR valves without inducing excessive and distortive assembly axial stresses. The resulting joint reduces wear and hysteresis of a valve relative to a prior art assembly.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. An apparatus for connecting a shaft to an armature of an actuator for actuation of the shaft by the actuator comprising:
a) said armature of said actuator having an axial bore therethrough for receiving a portion of said shaft;
b) a shoulder formed on said shaft for limiting the distance of ingress of said shaft through said axial bore;
c) a resilient element disposed on said shaft extending beyond said axial bore; and
d) a retainer for retaining said resilient element against a surface of said armature to capture said armature between said resilient element and said shoulder.

2. An apparatus in accordance with claim 1 further comprising a stop in engagement with said shoulder and said armature to transfer load therebetween.

3. An apparatus in accordance with claim 1 wherein said shoulder is tapered.

4. An apparatus in accordance with claim 3 further comprising a stop in engagement with said armature and said tapered portion of said shoulder to transfer load therebetween.

5. An apparatus in accordance with claim 4 wherein a portion of said stop in engagement with said tapered portion of said shoulder is tapered.

6. An apparatus in accordance with claim 1 wherein said resilient element is a wave washer.

7. An apparatus in accordance with claim 1 further comprising:
a) a retainer surrounding said shaft;
b) a clip receiving feature formed in said shaft; and
c) a clip disposed in said clip receiving feature for retaining and positioning said retainer with said resilient element in compression.

8. An apparatus in accordance with claim 1 wherein said shaft is a valve stem of a pintle valve assembly and wherein said actuator is a solenoid actuator of said valve stem.

9. An apparatus in accordance with claim 8 wherein said pintle valve assembly is an exhaust gas recirculation valve for an internal combustion engine.

10. An internal combustion engine, comprising a pintle-type exhaust gas recirculation valve having an actuator for linear actuation of a valve stem of the valve, comprising:
a) an armature of said actuator having an axial bore therethrough for receiving a portion of said valve stem;
b) a shoulder formed on said valve stem for limiting the distance of ingress of said valve stem through said axial bore;
c) a resilient element disposed on said valve stem extending beyond said axial bore; and
d) a retainer for retaining said resilient element against a surface of said armature to capture said armature between said resilient element and said shoulder.
